(19) United States
(12) Patent Application Publication
(10) Pub. No.: US 2007/0245341 A1
(43) Pub. Date: Oct. 18, 2007

(54) SYSTEM AND METHOD FOR PERFORMING AUTOMATIC SOFTWARE INSTALLATIONS AND AUTOMATIC SOFTWARE EXECUTIONS IN A TO-BE-TESTED COMPUTER

(75) Inventors: TAN-CHIANG WANG, Tu-Cheng (TW); XIN-CHENG AI, Shenzhen (CN); SHI CHENG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/565,639

(22) Filed: Dec. 1, 2006

(30) Foreign Application Priority Data
Dec. 9, 2005 (CN) 200510102292.0

(51) Int. Cl. G06F 9/445

(52) U.S. Cl. 717/174

(57) ABSTRACT

A system for performing automatic software installations and automatic software executions in a to-be-tested computer is disclosed. The system includes: a storing module (101) for storing installation and execution user-step data in the host computer 10, and generating an initialization file in the host computer (10) according to the installation and execution user-step data, a receiving module (102) for receiving software option list in a to-be-tested computer (11), and an automating module (103) for performing automatic installations and automatic executions of each software of the software option list in the to-be-tested computer (11). A related method is also disclosed.

### BACKGROUND OF THE INVENTION

1. Field of the Invention

The present invention relates to a system and method for performing automatic software installations and automatic software executions in a to-be-tested computer.

2. Description of Related Art

Ever since the market demand for computers grew, more and more manufacturers have begun producing computers. Before a manufactured computer is put into the market, each computer should pass a factory acceptance test. Such tests, involving a variety of tests on the computers, include functional testing that requires testing software.

Usually, tested software is installed and executed on each newly manufactured computer by testers. The testers must first install the tested software on each newly manufactured computer, and then execute the tested software. Using such a process for functional testing of the computer tested is very time consuming.

Therefore, what is needed is a system and method for automating software installations and software executions in a to-be-tested computer, by that the users can test the newly manufactured computers conveniently.

### SUMMARY OF THE INVENTION

A system for performing automatic software installations and automatic software executions in a to-be-tested computer includes: a storing module configured for storing initialization data, installation user-step data, and execution user-step data in a host computer and generating initialization files for each software of a batch of software packages corresponding the initialization data, the installation user-step data, and the execution user-step data; a receiving module configured for receiving a software option list for the to-be-tested computer, receiving software execution iterations of each software on the software option list, and receiving an option list iterations of the software option list; and an automating module configured for performing automatic installations and automatic executions of each software of the software option list in the to-be-tested computer according to the initialization files and the software execution iterations and the option list execution iterations.

A related method for performing automatic software installations and automatic software executions in a to-be-tested computer includes the steps of: storing initialization data, installation user-step data, and execution user-step data in a host computer; generating initialization files for each software of a batch of software packages corresponding the initialization data, the installation user-step data, and the execution user-step data; receiving a software option list for the to-be-tested computer; receiving software execution iterations of each software of the software option list; receiving an option list execution iterations of the software option list; performing automatic installations of each software of the software option list in the to-be-tested computer according to the initialization files and the software execution iterations and the option list execution iterations; performing automatic executions of the software option list.

Other advantages and novel features of the embodiments will be drawn from the following detailed description with reference to the attached drawings.

### BRIEF DESCRIPTION OF THE DRAWINGS

FIG. 1 is a schematic diagram of hardware configuration of a system for performing automatic software installations and automatic software executions in a to-be-tested computer in accordance with a preferred embodiment;

FIG. 2 is a flowchart of a preferred method for performing automatic software installations and automatic software executions in a to-be-tested computer by utilizing the system of FIG. 1; and

FIG. 3 is a flowchart for performing automatic executions of the software option list of FIG. 2.

### DETAILED DESCRIPTION OF THE INVENTION

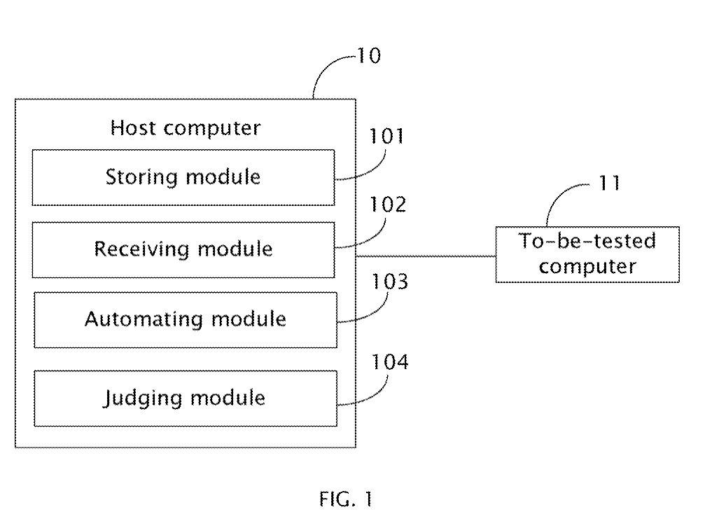

FIG. 1 is a schematic diagram of hardware configuration of a system for performing automatic software installations and automatic software executions in a to-be-tested computer (hereinafter, “the system”) in accordance with a preferred embodiment. The system includes: a host computer 10 and a to-be-tested computer 11. The host computer 10 is connected to the to-be-tested computer 11. The host computer 10 and/or the to-be-tested computer 11 may be a personal computer (PC), a notebook computer, a workstation, or the like.

Typically, the host computer 10 includes: a storing module 101, a receiving module 102, an automating module 103, and a judging module 104.

The storing module 101 is configured for storing initialization data, installation user-step data, and execution user-step data in the host computer 10. The installation user-step data and execution user-step data are user-input procedural instructions collected while manually installing and executing each software of a batch of software packages correspondingly. The storing module is also configured for generating initialization files (a.k.a *.ini files) for each software of the batch of software packages, the initialization files corresponds to the initialization data, the installation user-step data, and the execution user-step data.

The initialization data, the installation user-step data, and the execution user-step data include data paths corresponding to the installation user-steps and execution user-steps of each software of the batch of software packages. The user-steps are manual user input operations recorded while installing and executing each software in the batch of software packages. For example, the user may have to click on “INSTALL” button through a mouse on through a graphical user interface (GUI) to install one of the software, click on “NEXT” button to continue executing the tested software, press an “Enter” key on a keyboard to confirm an input operation of the tested software, or use any other suitable input device to install and execute any other software of the batch of software packages.

The receiving module 102 is configured for receiving a software option list for the to-be-tested computer 11, receiving software execution iterations of each software of the software option list, and receiving an option list execution iterations of the software option list. Each software of the software option list is a subset/item (individually included software) of the batch of software packages. Each software of the software option list may be executed over many iterations in order to extensively test the to-be-tested computer 11. The software execution iterations of each software and the option list execution of the software option list may be configured using a suitable input device of the host computer 10.

The automating module 103 is configured for performing automatic installations and automatic executions of each software of the software option list in the to-be-tested computer 11 according to the initialization files and the software execution iterations and the option list execution iterations. In the preferred embodiment, the automating module 103 performs automatic installations of each software of the software option list in the to-be-tested computer first, before performing automatic executions. When the automating module 103 performs automatic installations and automatic executions of each software of the software option list, the automating module 103 also automates all the user-steps. For example, the automating module 103 automates clicking “INSTALL” to install each software of the software option list, automates clicking “NEXT” to continue executing each software, and so on.

The automating module 103 may perform automatic execution of each software of the software option list over many iterations. During the iterations, a software may run continuously and fail to terminate properly because of a failure of the to-be-tested computer 11. When the automating module 103 performs automatic executions of the software option list, the automating module 103 performs automatic executions of software of the software option list one by one. I.e., the automating module 103 performs automatic executions of a first software of the software option list. After the automatic executions is/are complete, the automating module 103 determines whether the automatic executions of each software of the software option list are complete. If the automatic executions of each of the software of each software option list are not complete, the receiving module 102 determines whether to restart the to-be-tested computer 11. If there is no need to restart the to-be-tested computer 11, the automating module 103 performs automatic executions of a next software of the software option list. Otherwise, the automating module 103 performs automatic executions of the next software after the to-be-tested computer 11 is restarted.

The judging module 104 is configured for determining whether to perform automatic installations and automatic executions of another software option list in the to-be-tested computer 11. If there is a need to perform automatic installations and automatic executions of the other software option list, the automating module 103 performs automatic installations and automatic executions of the other software option list in the to-be-tested computer 11. This software option list is also included in the batch of software packages.

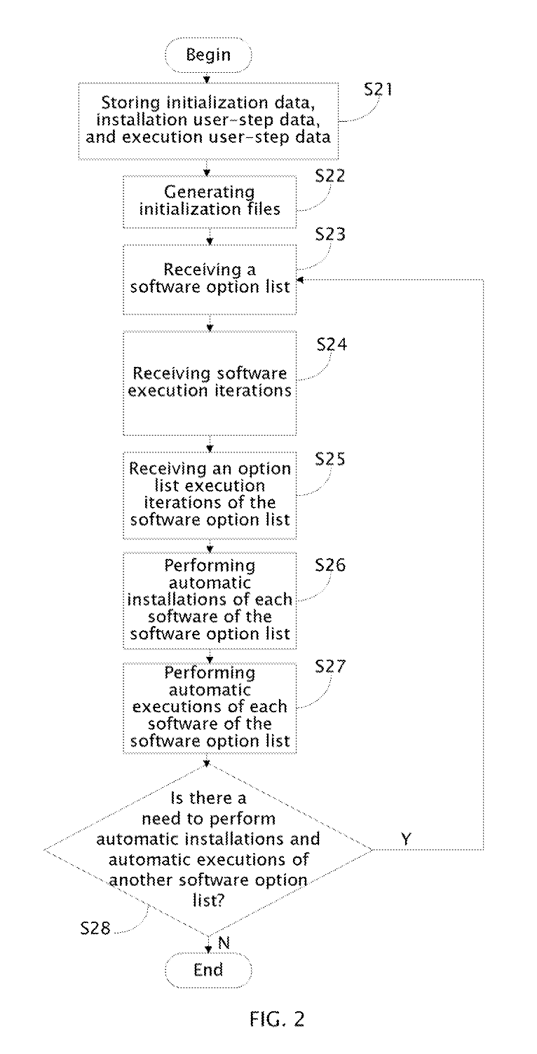

FIG. 2 is a flowchart of a preferred method for automating software installations and software executions in the to-be-tested computer 11 by utilizing the system of FIG. 1. In step S21, the storing module 101 stores initialization data, installation user-step data, and execution user-step data in the host computer 10.

In step S22, the storing module 101 generates initialization files for each software of a batch of software packages corresponding the initialization data, the installation user-step data, and the execution user-step data.

In step S23, the receiving module 102 receives a software option list for the to-be-tested computer 11.

In step S24, the receiving module 102 receives software execution iterations of each software of the software option list.

In step S25, the receiving module 102 receives an option list execution iterations of the software option list.

In step S26, the automating module 103 performs automatic installations of each software of the software option list in the to-be-tested computer 11 according to the initialization files and the software execution iterations and the option list execution iterations.

In step S27, the automating module 103 performs automatic executions of each software of the software option list.

In step S28, the judging module 104 determines whether to perform automatic installations and automatic executions of another software option list in the to-be-tested computer 11. If there is a need to perform automatic installations and automatic executions of the other software option list, the procedure returns to step S23.

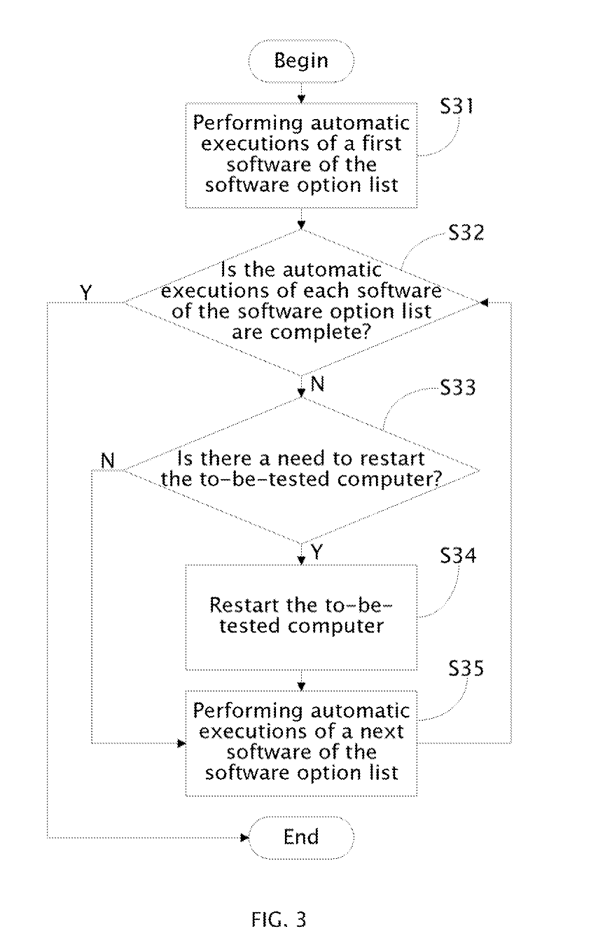

FIG. 3 is a flowchart for step S27 in FIG. 2, namely automating executions of the software option list. In step S31, the automating module 103 performs automatic executions of a first software of the software option list.

In step S32, the automating module 103 determines whether the automatic executions of each software of the software option list are complete.

If the automatic executions of each software of the software option list are not complete, in step S33, the receiving module 102 determines whether to restart the to-be-tested computer 11.

If there is a need to restart the to-be-tested computer 11, in step S34, the receiving module 102 restarts the to-be-tested computer 11.

In step S35, the automating module 103 performs automatic executions of a next software of the software option list. Afterward, the procedure returns to step S32.

In step S33, if there is no need to restart the to-be-tested computer 11, the procedure going directly to the step of S35.

In step S32, if the automatic executions of each software of the software option list are complete, the procedure ends.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for performing automatic software installations and automatic software executions in a to-be-tested computer, the system comprising:
a storing module configured for storing initialization data, installation user-step data, and execution user-step data in a host computer and generating initialization files for each software of a batch of software packages corresponding the initialization data, the installation user-step data, and the execution user-step data;
a receiving module configured for receiving a software option list for the to-be-tested computer, receiving software execution iterations of each software on the software option list, and receiving an option list iterations of the software option list; and
an automating module configured for performing automatic installations and automatic executions of each software of the software option list in the to-be-tested computer according to the initialization files and the software execution iterations and the option list execution iterations.

2. The system according to claim 1, wherein the initialization data, the installation user-step data, and the execution user-step data each comprise: data paths corresponding to the installation user-steps and execution user-steps of each software of the batch of software packages.

3. The system according to claim 1, wherein the automating module is further configured for determining whether the automatic executions of each software of the software option list are completed.

4. The system according to claim 1, wherein the receiving module is further configured for determining whether to restart the to-be-tested computer if the automatic executions of each software of the software option list are not completed.

5. The system according to claim 1, further comprising:
a judging module configured for determining whether to perform automatic installations and automatic executions of another software option list in the to-be-tested computer.

6. The system according to claim 1, wherein the batch of software packages comprises all software option lists to be installed and executed in the to-be-tested computer.

7. A method for automating software installations and software executions in a to-be-tested computer, the method comprising the steps of:
storing initialization data, installation user-step data, and execution user-step data in a host computer;
generating initialization files for each software of a batch of software packages corresponding the initialization data, the installation user-step data, and the execution user-step data;
receiving a software option list for the to-be-tested computer;
receiving software execution iterations of each software of the software option list;
receiving an option list execution iterations of the software option list;
performing automatic installations of each software of the software option list in the to-be-tested computer according to the initialization files and the software execution iterations and the option list execution iterations;
performing automatic executions of the software option list.

8. The method according to claim 7 wherein the step of automating executions of the software option list comprises the steps of:
performing automatic executions of a first software of the software option list;
determining whether the automatic executions of each software of the software option list are complete;
determining whether to restart the to-be-tested computer if the automating executions of each software of the software option list are not complete;
restarting the to-be-tested computer if there is a need to restart the to-be-tested computer; and
performing automatic executions of a next software of the software option list.

9. The method according to claim 8, further comprising the step of:
going directly to the step of performing automatic executions of a next software of the software option list if there is no need to restart the to-be-tested computer.

10. The method according to claim 7, further comprising the steps of:
determining whether to perform automatic installations and automatic executions of another software option list.
